(19) United States
(12) Patent Application Publication
(10) Pub. No.: US 2013/0217370 A1
(43) Pub. Date: Aug. 22, 2013

(54) Protective Helmet with Voice-Activated Telephonic and Route-Guidance Systems

(71) Applicants: Rajhon Gerald, East Orange, NJ (US); Tariq Ruff, Rutherford, NJ (US)

(72) Inventors: Rajhon Gerald, East Orange, NJ (US); Tariq Ruff, Rutherford, NJ (US)

(21) Appl. No.: 13/401,383

(22) Filed: Feb. 21, 2012

(51) Int. Cl. H04W 4/02; H04W 4/16

(52) U.S. Cl. 455/415

(57) ABSTRACT

A protective helmet utilizes Bluetooth technology to integrate components of a hands-free, voice-activated telephonic communication system and a hands-free, voice-activated route guidance system. The Bluetooth transceiver provides the hub through which communications among the various components of the telephonic and route guidance systems take place.

Incoming calls can be screened based on audible caller-IDs and outgoing calls placed based on spoken identifiers. In response to a spoken destination name, audible turn-by-turn route instructions are generated.

### BACKGROUND OF THE INVENTION

The present invention relates to the field of crash helmets equipped with hands-free voice-activated mobile telephone and/or navigation systems.

### SUMMARY OF THE INVENTION

Although the use of mobile phones and route guidance systems, or “navigators,” while operating motor vehicles has become commonplace, it can be hazardous if not properly implemented. This is particularly true with respect to the class of motor vehicles for which safe operation requires wearing a protective helmet. In the case of a moving motorcycle, for example, there is no safe way for the rider to operate cellular phones or navigation aides either manually or visually. What is needed is a system that can be integrated with the helmet itself to allow wireless telephonic communication and route guidance through purely audible commands and responses.

The present invention utilizes Bluetooth technology to integrate within a motorcycle helmet the necessary elements of a hands-free wireless communication and navigation system. The central component of the system is a Bluetooth transceiver, which provides the “hub” through which communications among various Bluetooth-enabled components takes place.

With regard to wireless telecommunications, the present invention provides audible caller-ID on incoming calls, and the wearer of the helmet controls call answering with verbal commands. On out-going calls, the wearer simply says the name or description of the party to be called, and a voice recognition system translates that into a phone number which is transmitted to the cell phone placing the call.

A Bluetooth transceiver links the components of this system, which comprise a microphone, headphones, voice generation and voice recognition units, all of which are located inside the helmet. A dedicated mobile telephone can also be integrated within the helmet, either internally or externally, or alternatively an independent mobile phone can be externally plugged into the helmet through a phone docking cradle. The mobile phone itself can be equipped with caller-ID and/or phone number generation/lookup functions, or these functions can be provided by stand-alone units.

With regard to route guidance and navigation, the present invention again uses the Bluetooth transceiver to link the key components. The wearer of the helmet speaks the destination address or name into the microphone, which is linked through the Bluetooth to the voice recognition unit. The latter then provides destination text to a GPS and route calculator, which may be integrated or stand-alone units. The route calculator sends route text via the Bluetooth to a voice generator, which translates the textual route into turn-by-turn route directions audible through the headphones.

Other features of the present invention include an internal ventilation system, which is useful in preventing heat buildup from the electronic components and power supply inside the helmet. The internal padding of the helmet is preferably washable form-fitting memory foam, comprising visco-elastic or low-resilience polyurethane foam, to minimize head movement which might misalign the microphone and headphone components. Another optional feature is a photo-chromatic visor, which darkens in strong sunlight to reduce visual glare and heat buildup.

The foregoing summarizes the general design features of the present invention. In the following sections, a specific embodiment of the present invention will be described in some detail. This specific embodiment is intended to demonstrate the feasibility of implementing the present invention in accordance with the general design features discussed above. Therefore, the detailed description of this embodiment is offered for illustrative and exemplary purposes only, and it is not intended to limit the scope either of the foregoing summary description or of the claims which follow.

### BRIEF DESCRIPTION OF THE DRAWINGS

FIG. 1 is a side profile view of the preferred embodiment of the present invention;

FIG. 2 is a schematic diagram of the hands-free incoming call answering function of the preferred embodiment of the present invention;

FIG. 3 is a schematic diagram of the hands-free outgoing call function of the preferred embodiment of the present invention; and

FIG. 4 is a schematic diagram of the hands-free route guidance function of the preferred embodiment of the present invention.

### DETAILED DESCRIPTION OF THE PREFERRED EMBODIMENT

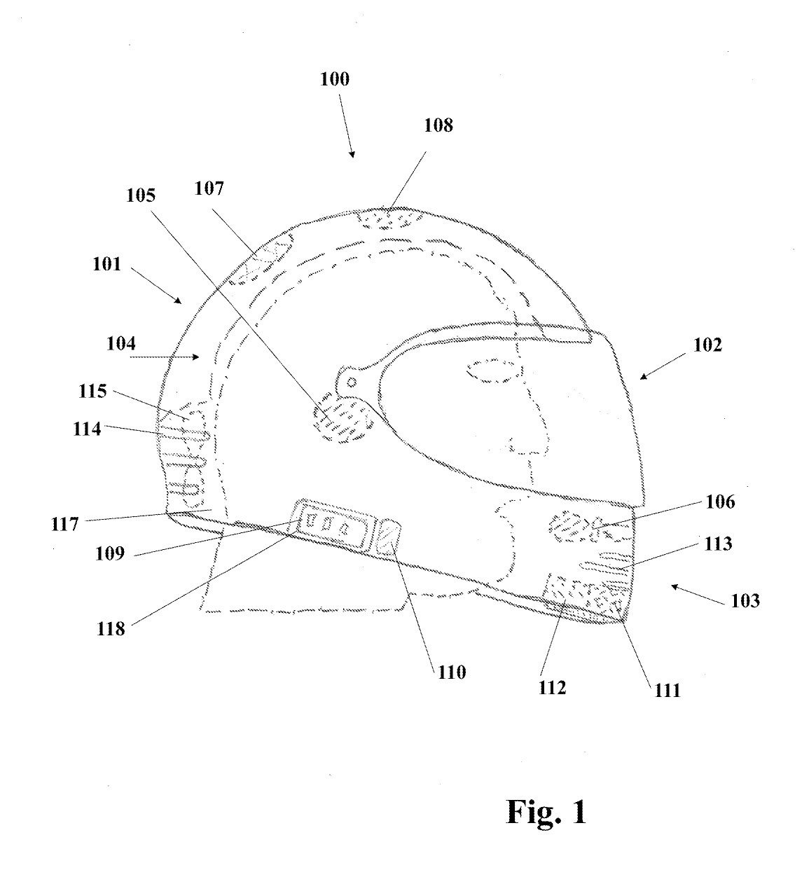

Referring to FIG. 1, the preferred embodiment of the present invention consists of a protective helmet 100, comprising an outer shell 101, a visor 102, a chin bar 103 and inner padding 104. Located within the helmet 100 are headphones 105, a microphone 106, a Bluetooth transceiver 107, a global positioning system (GPS) unit 108, a voice recognition unit 111 and a voice generation unit 112. All electronic components are Bluetooth-enabled.

Attached externally to the helmet 100 is a Bluetooth-enabled wireless mobile phone 109 equipped with caller-ID, which phone is preferably an independent stand-alone unit connected to the helmet 100 through a Bluetooth-enabled docking cradle 118. Also attached externally to the helmet 100 is a phone number generator 110, comprising a flash drive or memory chip containing a list of frequently called telephone numbers, each associated with an identifying name or description.

Located inside the helmet 100 are a voice recognition unit 111, which translates spoken words into digitally-encoded text, and a voice generation unit 112, which translates digitally-encoded text into spoken words.

Air inlet vents 113 and cooperating air outlet vents 114 are provided in the helmet 100, with air movement between them induced by a small exhaust fan 115. A power supply 117 provides electric energy to the fan 115 and other electrical components. Internal helmet padding 104 is preferably of the polyurethane “memory foam” type. The visor 102 optionally can be a photo-chromatic material that darkens in sunlight.

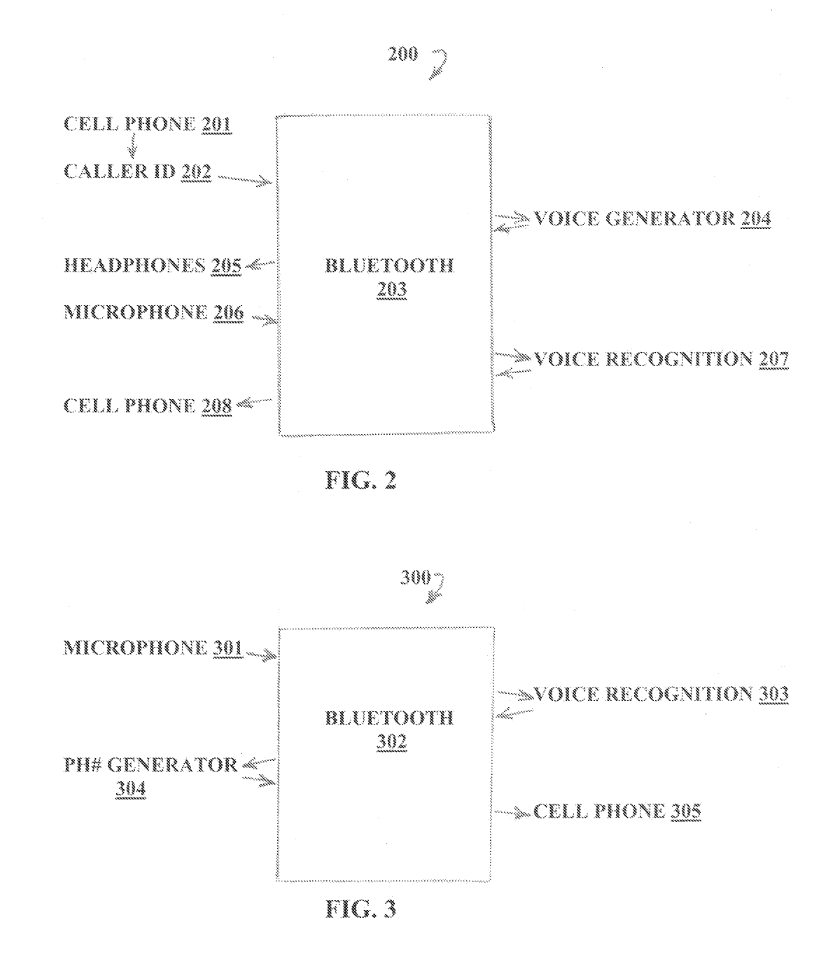

FIG. 2 illustrates the hands-free function of answering an incoming wireless telephone call 200. The phone 201 generates a caller-ID 202, which is transmitted as digital text via the Bluetooth transceiver 203 to the voice generation unit 204. The voice generation unit 204 transmits a modulated signal through the Bluetooth 203 to the headphones 205, wherein the signal produces an audible sound which vocalizes the name of the caller. The wearer of the helmet 100 then speaks an audible command into the microphone 206. The audible command is transmitted through the Bluetooth 203 to the voice recognition unit 207, which sends a signal back through the Bluetooth 203 to the mobile phone 208, telling it whether to answer the call or take a message. If answered, the call would then be conducted through the microphone 206 and headphones 205 in the manner of a typical hands-free call.

FIG. 3 schematically depicts the hands-free function of placing an outgoing wireless telephone call 300. The wearer of the helmet 100 speaks the name or description of the party to be called into the microphone 301, which transmits a modulated signal through the Bluetooth transceiver 302 to the voice recognition unit 303. The voice recognition unit 303 then translates the name/description of the party to be called into digital text, which is sent through the Bluetooth 302 to the phone number generator 304. The phone number generator 304 associates a specific phone number with the name/description of the party to be called and transmits that phone number to the mobile phone 305, which paces the call.

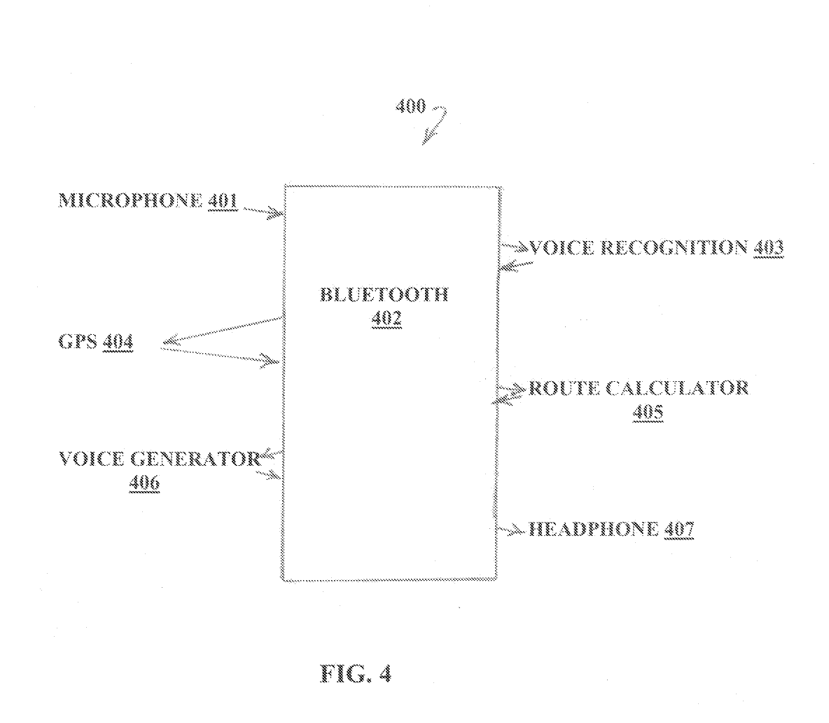

FIG. 4 schematically illustrates the hands-free route guidance function 400. The wearer of the helmet 100 speaks the address or name of the desired destination into the microphone 401, which transmits a modulated signal through the Bluetooth transceiver 402 to the voice recognition unit 403. The voice recognition unit 403 translates the destination address/name into digital text and sends it via the Bluetooth 402 to the GPS 404, which determines the coordinates of the current location and the destination and sends both coordinates in digital format through the Bluetooth 402 to a route calculator 405. The route calculator 405 can be a stand-alone unit, but it is preferably integrated with the GPS system, as is typical for automobile route guidance “navigation units.” In either case, the route calculator 405 calculates the best route between the current coordinates and the destination coordinates and sends a series of turn-by-turn instructions as digital text through the Bluetooth 402 to the voice generation unit 406. The voice generation unit 406 translates the digital text instructions into verbal turn-by-turn instructions that are transmitted through the Bluetooth 402 to the headphones 407, through which they are audible.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A protective helmet with integrated voice-activated telephonic and route guidance systems, comprising:
a Bluetooth transceiver located inside the helmet;
multiple electronic communication components which are capable of communicating with each other through the Bluetooth transceiver;
wherein the electronic communication components include a microphone, headphones, a global positioning system (GPS), a route calculator which calculates the optimal route between two GPS coordinates and generates turn-by-turn route instructions, a wireless telephone which generates caller-identification texts for incoming calls, a digital memory device which stores and retrieves telephone numbers based on names or other identifiers, a voice generator unit which translates digital text into corresponding audible speech, and a voice recognition unit which translates audible speech into digital text;
wherein the integrated voice-activated telephonic system uses the voice generation unit to translate the caller-identification texts of incoming calls into verbal caller-identifications audible through the headphones;
wherein the integrated voice-activated telephonic system uses the voice recognition unit to translate verbal commands spoken into the microphone into signals to control the operation of the wireless telephone;
wherein the integrated voice-activated route guidance system uses the voice recognition unit to translate a verbal identifier of a destination spoken into the microphone into digital destination data, from which the route calculator generates digital text turn-by-turn route instructions to the destination from an original position determined by the GPS; and
wherein the integrated voice-activated route guidance system uses the voice generator unit to translate the digital text turn-by-turn route instructions into verbal turn-by-turn route instructions audible through the headphones.

2. The helmet according to claim 1, wherein an exhaust fan located inside the helmet draws air into the helmet through one or more inlets and exhausts air from the helmet through one or more outlets.

3. The helmet according to claim 2, wherein the helmet has a visor made of a photo-chromatic material.

4. The helmet according to claim 3, wherein the helmet has interior polyurethane memory foam padding.
